(19) United States
(12) Patent Application Publication
(10) Pub. No.: US 2007/0190287 A1
(43) Pub. Date: Aug. 16, 2007

(54) Carpet and process for producing the same

(75) Inventors: Yasutaro Seto, Osaka (JP); Shuichi Gennaka, Nara (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SUMINOE TEXTILE CO., LTD., OSAKA-SHI, OSAKA JAPAN (JP)

(21) Appl. No.: 10/592,113

(22) PCT Filed: Mar. 8, 2005
(86) PCT No.: PCT/JP05/03981

§ 371 Date: Sep. 8, 2006

(30) Foreign Application Priority Data
Mar. 11, 2004 (JP) 2004-068978
Mar. 11, 2004 (JP) 2004-068979

(51) Int. Cl. D05C 17/00; D03D 27/00; B32B 33/00

(52) U.S. Cl. 428/96; 428/95; 428/97; 156/72

(57) ABSTRACT

A carpet has piles 2 provided on an upper surface of a base fabric 3 and a backing layer 4 formed on a lower surface of the base fabric 3. An allergen reducing agent 10 is made to adhere to at least a part of an area X ranging from the upper surface of the base fabric 3 to a foot portion of the pile. With this structure, allergens, such as, e.g., mites, dead mites, or pollen, especially entered in the carpet, can be efficiently inactivated and the amount of allergens in the carpet can be reduced.

### TECHNICAL FIELD

The present invention relates to a carpet having a function of inactivating allergens, such as, e.g., pollen or mites adhered to the carpet, and also relates to a process for producing the same.

### BACKGROUND TECHNIQUE

Recently built housings are remarkably improved in thermal insulation performance and airtightness. A high performance energy-saving housing in which it takes a time for the indoor air to be replaced by a natural circulation several times than a conventional housing has been developed. In such a designed housing, however, it is said that odor, dust called house dust, or the like, tends to be kept within the housing because of the high airtightness and turns into allergens causing for allergy to develop various symptoms of allergic diseases, such as, e.g., atopic dermatitis, bronchial asthma, or allergic rhinitis.

There are various types of allergens, such as, e.g., mites (including their live bodies, dead bodies, empty shells, and excrements), molds, pets (including their coats, and scurf), pollen, which are considered to be main causative agents of allergic diseases. For example, even if dust mites which are allergens are exterminated by high temperatures or medical agents, the dead bodies remain in the carpet. Such dead bodies of the dust mites will be released from the inside of the carpet into the room space when people walk or move on the carpet, which was seen as a problem (the dead bodies of the dust mites especially cause a problem because of its high allergenicity). Accordingly, it was difficult to prevent the development of the allergic diseases due to the allergens, such as, e.g., mites, dead mites, mite's empty shells, and mite's excrements, unless the allergens are removed from the carpet.

Under the circumstances, odor elimination and/or dust collection using air conditioners, air cleaning equipments, etc., have become popular. For example, a method of collecting allergens in the air with a filter, etc., is proposed. Although the collecting method using air conditioners, air cleaning equipments, etc., are effective to collect allergens suspended in the air, it has almost no effect on the collection of allergens adhered to carpets. In order to remove allergens adhered to carpets, it is said to be effective to repeatedly vacuum a carpet while tapping the surface layer portion of the piles with a vacuum cleaner, etc. With this method, although allergens adhered to the surface of the carpet could be removed, allergens such as mites or dead mites entered the carpet could not be sufficiently removed. If sufficient removal of such allergens such as mites or dead mites entered the carpet cannot be attained, an opportunity for people using carpets to contact those allergens cannot be sufficiently reduced. Therefore, it is hardly to say that living environment capable of sufficiently preventing development of allergic diseases has been attained.

On the other hand, products, such as fabrics or fibers, having an allergen reducing function by allergen reducing components adhered to fibers are disclosed by the below-listed Patent Documents 1 to 3. That is, Patent Document 1 discloses a carpet wiping sheet in which allergen reducing components are impregnated in the base fabric (e.g., woven fabric, nonwoven fabric). Patent Document 2 discloses an allergen reducing fibers to which allergen reducing components are chemically bonded or adhered. Patent Document 3 discloses an allergen reducing nonwoven fabric in which ink containing allergen reducing components is printed on at least one surface of a nonwoven fabric.

Patent Document 1: Japanese Unexamined Laid-open Patent Publication No. 2003-10089

Patent Document 2: Japanese Unexamined Laid-open Patent Publication No. 2003-96670

Patent Document 3: Japanese Unexamined Laid-open Patent Publication No. 2003-313778

### DISCLOSURE OF THE INVENTION

### Problems to be Solved by the Invention

As mentioned above, conventionally, allergen reducing function bodies in which a fiber or a base fabric (e.g., woven fabric, nonwoven fabric) is fixedly impregnated with allergen reducing components are known. However, in a carpet equipped with piles on the surface which is a fiber assembly of a special structure, in other words, in a carpet having piles implanted on the upper surface of the base fabric and a backing layer formed on the lower surface of the base fabric, no carpet to which an allergen reducing agent is given has been proposed. Furthermore, there was no knowledge or teaching about the most effective portion of a carpet for supporting such allergen reducing agent. Accordingly, no conventional pile carpet having a function for inactivating allergens such as pollen or mites adhered to a carpet was available, and therefore it is hardly to say that living environment capable of sufficiently preventing development of allergic diseases has been attained.

The present invention was made in view of the aforementioned technical background, and aims to provide a carpet capable of reducing an amount of allergens, such as, e.g., mites, dead mites, or pollen, especially entered the carpet by effectively inactivating the allergens, and also to provide a production method of the carpet.

### MEANS TO SOLVE THE PROBLEMS

Devoting researches to attain the aforementioned objects, the present inventors found the fact that allergen substances, such as, e.g., mites, mites bodies, or pollen, are accumulated especially at the foot portions of piles of a carpet as the pile carpet is used for a long period of time. Based on this finding, in order to decrease the amount of allergens adhered to a pile carpet by effectively inactivating the allergens, the inventors considered it important to selectively make allergen reducing agents adhere to the pile foot portion or the vicinity thereof, and further investigated the concrete structure. As a result, the inventors have completed the present invention. That is, the present invention provides the following means.

[1] A carpet having piles provided on an upper surface of a base fabric and a backing layer formed on a lower surface of the base fabric,
wherein an allergen reducing agent is made to adhere to at least a part of an area ranging from the upper surface of the base fabric to a foot portion of the pile.

[2] A carpet having piles provided on an upper surface of a base fabric and a backing layer formed on a lower surface of the base fabric,
wherein an allergen reducing agent is made to adhere to the upper surface of the base fabric.

[3] A carpet having piles provided on an upper surface of a base fabric and a backing layer formed on a lower surface of the base fabric,
wherein a web layer to which an allergen reducing agent is made to adhere is integrally laminated on the upper surface of the base fabric.

[4] The carpet as recited in the aforementioned item 3, wherein the base fabric and the web layer are integrally laminated by needling.

[5] The carpet as recited in any one of the aforementioned items 1 to 4, wherein weight per unit area of the web layer is 10 to 100 g/m².

[6] The carpet as recited in any one of the aforementioned items 1 to 5, wherein an adhered amount of the allergen agent is 1 to 10 g/m².

[7] A carpet having piles provided on an upper surface of a base fabric and a backing layer formed on a lower surface of the base fabric,
wherein the backing layer is made of a composition in which an allergen reducing agent is contained in resin and/or rubber, and
wherein a part of the composition is permeated in and adhered to a foot portion of the pile.

[8] The carpet as recited in the aforementioned item 7, wherein the backing layer is made of a composition containing 2 to 20 mass parts allergen reducing agent with respect to 100 mass parts main component of resin and/or rubber.

[9] The carpet as recited in the aforementioned item 7 or 8, wherein an adhered amount of the allergen reducing agent is 2 to 15 g/m².

[10] The carpet as recited in any one of the aforementioned items 1 to 9, wherein an allergen reducing agent having a phenolic hydroxyl group is used as the allergen reducing agent.

[11] A manufacturing method of a carpet, comprising:
applying a composition with viscosities of 5,000 to 25,000 mPa·s containing 2 to 20 mass parts allergen reducing agent with respect to 100 mass parts main component of resin and/or rubber onto a lower surface of a base fabric provided with pile on an upper surface of the base fabric; and thereafter
drying the composition applied to the base fabric.

[12] The manufacturing method of a carpet as recited in the aforementioned item 11, wherein the composition is applied to the lower surface of the base fabric by a roll coating method.

### EFFECTS OF THE INVENTION

In the invention as recited in [1], since an allergen reducing agent is made to adhere to at least a part of an area ranging from the upper surface of the base fabric to a foot portion of the pile, the allergen reducing agent can effectively act on the allergens, such as, e.g., mites, dead mites, and pollen, which tend to be accumulated mainly at the foot portion of the pile. As a result, the allergens existing mainly at the foot portion of the pile can be effectively inactivated to sufficiently reduce the amount of allergens. Therefore, the use of this pile carpet contributes to the realization of living environment capable of sufficiently preventing the development of allergic diseases.

In the invention as recited in [2], since an allergen reducing agent is made to adhere to the upper surface of the base fabric, the allergen reducing agent can effectively act on the allergens, such as, e.g., mites, dead mites, and pollen, which tend to be accumulated mainly at the foot portion of the pile. As a result, the allergens existing mainly at the foot portion of the pile can be effectively inactivated to sufficiently reduce the amount of allergens. Therefore, the use of this pile carpet contributes to the realization of living environment capable of sufficiently preventing the development of allergic diseases.

In the invention as recited in [3], since a web layer to which an allergen reducing agent adheres is integrally laminated on the upper surface of the base fabric, the allergen reducing agent can effectively act on the allergens, such as, e.g., mites, dead mites, and pollen, which tend to be accumulated mainly at the foot portion of the pile. As a result, the allergens existing mainly at the foot portion of the pile can be effectively inactivated to sufficiently reduce the amount of allergens. According to this invention as recited in [3], allergen reducing effects superior to those of the invention as recited in [2] can be obtained because it is considered that the existence of the web layer on the upper surface of the base fabric further improves the contact efficiency between the allergen reducing agent and the allergens existing at the foot portion of the pipe.

In the invention as recited in [4], since the base fabric and the web layer are integrally laminated by needling, the web layer can be integrally laminated with respect to the base fabric in a stable and strong manner.

In the invention as recited in [5], since weight per unit area of the web layer is 10 to 100 g/m², the contact efficiency between the allergen reducing agent and the allergens can be further improved.

In the invention as recited in [6], since an adhered amount of the allergen agent is 1 to 10 g/m², the amount of allergens in the carpet can be sufficiently reduced while reducing the cost.

In the invention as recited in [7], since a part of the composition containing an allergen reducing agent constituting the backing layer is permeated in and adhered to a foot portion of the pile, the allergen reducing agent can effectively act on the allergens, such as, e.g., mites, dead mites, and pollen, which tend to be accumulated mainly at the foot portion of the pile. As a result, the allergens existing mainly at the foot portion of the pile can be effectively inactivated to sufficiently reduce the amount of allergens. Therefore, the use of this pile carpet contributes to the realization of living environment capable of sufficiently preventing the development of allergic diseases.

In the invention as recited in [8], since the backing layer is made of a composition containing 2 to 20 mass parts allergen reducing agent with respect to 100 mass parts main component of resin and/or rubber, the allergen amount reducing effects can be further enhanced.

In the invention as recited in [9], since an adhered amount of the allergen reducing agent is 2 to 15 g/m², the allergen amount reducing effects can be further enhanced.

In the invention as recited in [10], since an allergen reducing agent having a phenolic hydroxyl group is used as the allergen reducing agent and the allergen reducing agent having a phenolic hydroxyl group is especially excellent in allergen inactivation performance, the amount of allergens in the carpet can be further reduced.

In the invention as recited in [11], since the backing layer is formed by applying a composition with viscosities of 5,000 to 25,000 mPa·s containing a certain amount of allergen reducing agent to a lower surface of a base fabric, a part of the composition adheres to the foot portion of the pile by permeating the base fabric. Thus, in the carpet manufactured in accordance with this method, the allergens existing mainly at the foot portion of the pile portion can be effectively inactivated, which can sufficiently reduce the amount of the allergens.

In the invention as recited in [12], since the composition is applied by a roll coating method, the degree of permeation (height of permeation) of the composition into the pile foot portion can be controlled with a high degree of accuracy, which in turn enables a manufacturing of a carpet excellent in tactile impression of the pile surface and having a stable allergen reducing function.

### BRIEF DESCRIPTION OF THE DRAWINGS

FIG. 1 is a cross-sectional view showing a first embodiment of a carpet according to the present invention.

FIG. 2 is a cross-sectional view showing a second embodiment of a carpet according to the present invention.

FIG. 3 is a cross-sectional view showing a third embodiment of a carpet according to the present invention.

### DESCRIPTION OF THE REFERENCE NUMERALS

1 . . . carpet
2 . . . pile
3 . . . base fabric
4 . . . backing layer
5 . . . web layer
10 . . . allergen reducing agent
21 . . . pile foot portion
X . . . area ranging from the upper surface of the base fabric to the pile foot portion

### BEST MODE FOR CARRYING OUT THE INVENTION

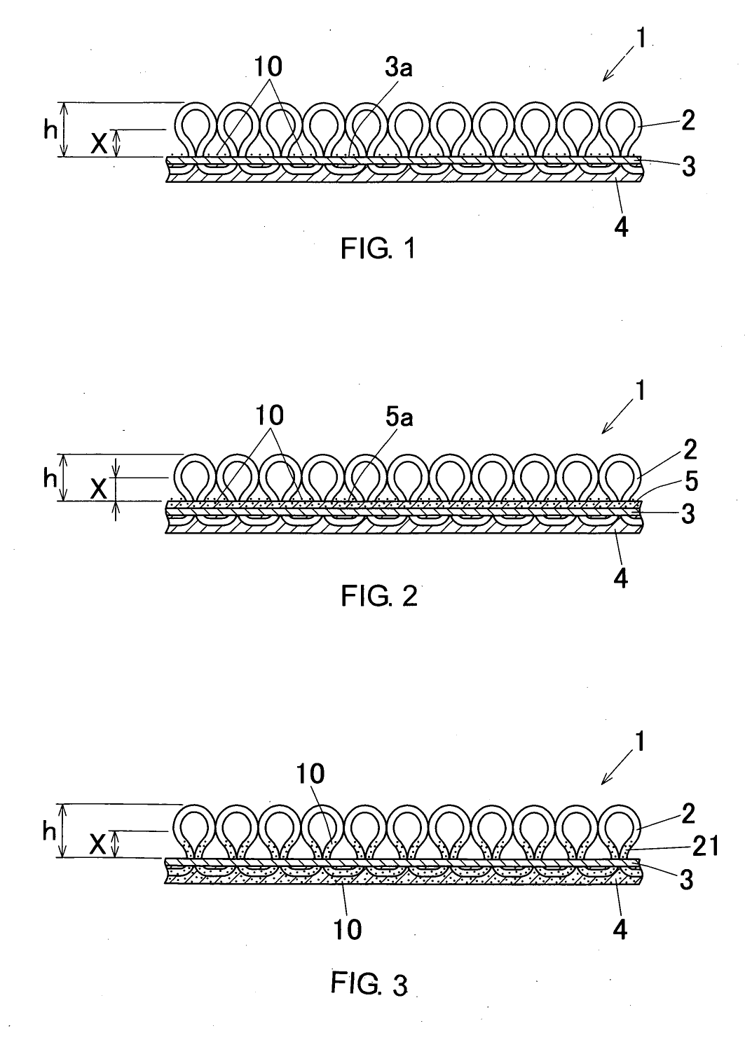

The carpet 1 according to the present invention is characterized in that piles 2 are implanted in the upper surface of the base fabric 3, a backing layer 4 is formed on the lower surface of the base fabric 3, and an allergen reducing agent is made to adhere to at least a part of an area X ranging from the upper surface of the base fabric 3 of the foot portion 21 to the pile foot portion 21 (see FIGS. 1 to 3).

In the aforementioned carpet 1, since the allergen reducing agent 10 is made to adhere to at least a part of an area X ranging from the upper surface of the base fabric 3 of the foot portion 21 to the pile foot portion 21, the allergen reducing agent 10 can effectively act on the allergens, such as, e.g., mites, dead mites, or pollen, accumulated mainly at the foot portion 21 of the pile portion 2. This effectively inactivates the allergens existing mainly at the foot portion 21 of the pile portion 2, which sufficiently reduces the amount of allergens in the carpet 1.

The aforementioned “pile foot portion 21” denotes the area X in the pile 2 ranging from the height position corresponding to the upper surface of the base fabric to the half of the pile height h (see FIGS. 1 to 3)

FIG. 1 shows a carpet according to a first embodiment of the present invention. In this carpet 1, piles 2 are implanted in the upper surface 3a of the base fabric 3, and the backing layer 4 is formed on the lower surface of the base fabric 3. An allergen reducing agent 10 is made to adhere to the upper surface of the base fabric 3.

In this embodiment, since the allergen reducing agent 10 is made to adhere to the upper surface 3a of the base fabric 3 by binder resin, the detachment of the allergen reducing agent 10 can be sufficiently prevented even if the carpet is washed for example, resulting in a long-lasting allergen reducing function.

In the carpet 1 shown in FIG. 1, after applying binder resin containing an allergen reducing agent 10 onto the upper surface 3a of the base fabric 3 by coating or the like, a pile yarn 2 is implanted in the base fabric 3 from the lower surface side using a tufting machine. Subsequently, the pile yarn 2 is fixed to the base fabric 3 by bucking the lower surface of the base fabric 3 with a backing material.

As to a method of making the allergen reducing agent 10 adhere to the upper surface 3a of the base fabric 3, although it is not limited to a specific method, a method in which an allergen reducing agent is uniformly dispersed in a binder resin solution and applied onto one surface of the base fabric 3 by a method, such as, e.g., a spraying method or a coating method, and thereafter drying process is executed to fixedly make the allergen reducing agent adhere thereto can be exemplified. The drying of the binder resin solution is not specifically limited, and it is preferable that the binder resin solution is dried by a heat treatment in view of the dry processing efficiency. The heat treatment temperature varies depending on the material of the base fabric, but is preferably set to 100 to 180° C. The heat treatment executed within this temperature range causes further enhanced fixing to the base fabric 3, which in turn can further improve the durability of the allergen reducing performance.

The binder resin and the allergen reducing agent are preferably applied in the water dispersion form. The binder resin is preferably made to form an emulsion state between the binder resin and water. As the dispersing medium, alcohol, etc., can be used other than water, but water is preferably used. As to the order of dispersing the allergen reducing agent, from the viewpoint of evenly dispersing the allergen reducing agent and the binder resin, it is preferable that the allergen reducing agent is preliminarily dispersed in water and then the binder resin is dispersed therein. Various additive agents, such as, e.g., dispersing agents or thickening agents, can be added to the aforementioned water dispersions.

As the binder resin, it is not specifically limited if it is possible to make the allergen reducing agents 10 adhere to the base fabric 3. Examples of such binder resin include urethane resin, self-bridging type acrylic resin, methacrylic resin, silicone resin, glyoxal resin, polyester resin, acetic acid vinyl resin, vinylidene chloride resin, butadiene resin, melamine resin, epoxy resin, acryl-silicone co-polymer resin, ethylene-vinyl acetate co-polymer resin (EVA), isobutylene maleic anhydride co-polymer resin, and ethylene-styrene-acrylate-methacrylate co-polymer resin. The binder resin can be a mixture of two or more of the aforementioned resins. Among other things, EVA is most preferably used because of its excellent adhesiveness.

FIG. 2 shows a carpet 1 according to a second embodiment of the present invention. In this carpet 1, piles 2 are implanted on the upper surface of the base fabric 3, a backing layer 4 is formed on the lower surface of the base fabric 3, and a web layer 5 to which an allergen reducing agent 10 is made to adhere is integrally laminated on the upper surface of the base fabric 3. In this embodiment, the allergen reducing agent 10 is made to adhere to the entirety (inside and upper and lower surfaces) of the web layer 5. However, the invention is not limited to the above. For example, it can be configured that an allergen reducing agent 10 is made to adhere to the upper surface 5a of the web layer 5. Alternatively, it can be configured that an allergen reducing agent 10 is made to adhere to the inside of the web layer 5. Alternatively, it can be configured that an allergen reducing agent 10 is made to adhere to the lower surface (the surface to be superimposed by the base fabric) of the web layer 5.

In the carpet 1 shown in FIG. 2, an allergen reducing effect superior to that of the carpet shown in FIG. 1 can be obtained. The reason is considered as follows. That is, since the allergen decreasing agent adhered web layer 5 exists on the upper surface of the base fabric 3, the allergen decreasing agent 10 is located at a position closer to the foot portion 21 of the pile portion 2, which improves the contact efficiency between the allergen reducing agent 10 and the allergens.

The carpet 1 shown in FIG. 2 is manufactured by: impregnating a web 5 into a binder resin solution containing the allergen reducing agent 10 in a dispersed manner; thereafter integrally laminating the web 5 and the base fabric 3 by needling; then implanting the pile yarns 2 to the base fabric 3 from the lower surface thereof using a tufting machine; and subsequently fixing the pile yarns 2 to the base fabric 3 by backing the lower surface of the base fabric 3 with a backing material.

In the case of employing a structure in which an allergen reducing agent 10 is made to adhere to the upper surface of the web layer 5, such a structure can be obtained by, for example, integrally laminating the web 5 and the base fabric 3 by needling, and then applying binder resin containing an allergen reducing agent 10 onto the upper surface of the web 5 and then drying them.

As a method of making the allergen reducing agent 10 adhere to the web 5, other than the aforementioned method in which binder resin solution containing the allergen reducing agent 10 in a dispersed manner is impregnated in the web 5 and then dried, for example, a method in which an allergen reducing agent uniformly dispersed in a binder resin solution is applied onto the upper surface of the web 5 by, for example, a spraying method or a coating method and then dried to be fixed can be exemplified. The method of drying the binder resin solution is not specifically limited, and air drying and heat treatment can be exemplified. Considering the dry processing efficiency, a heat treatment can be preferably employed. The heat treatment temperature varies depending on the material of the web 5, but is preferably set to 100 to 180° C. The heat treatment at the temperature falling within the aforementioned range further enhances the fixing to the web 5, which in turn can further improve the durability of the allergen reducing performance. The binder resin and the allergen reducing agent are preferably applied in the water dispersion form. The binder resin preferably forms an emulsion state between the binder resin and water. As the dispersing medium, alcohol, etc., can be used other than water, but water is preferably used. As to the order of dispersing the allergen reducing agent, from the viewpoint of evenly dispersing the allergen reducing agent and the binder resin, it is preferable that the allergen reducing agent is preliminarily dispersed in water and then the binder resin is dispersed therein. Various additive agents, such as, e.g., dispersing agents or thickening agents, can be added to the aforementioned water dispersions.

As the binder resin, the same binder resin as that exemplified in the first embodiment can be exemplified.

In the second embodiment, it is preferable that the weight per unit area of the web layer 5 is 10 to 100 g/m². Setting it to 100 g/m² or less causes an easy entering of allergens into the web layer 5, resulting in further enhanced contact efficiency between the allergen reducing agent 10 and the allergens. Setting it to 10 g/m² or more causes a sufficient adhered amount of the allergen reducing agent to the web layer 5.

In the first and second embodiments, it is preferable that the adhered amount of the allergen reducing agent 10 is set so as to fall within the range of 1 to 10 g/m². Sufficient allergen reducing function can be attained if it is 1 g/m² or more, while cost reduction can be attained if it is 10 g/m² or less. Among other things, the adhered amount of the allergen reducing agent is preferably set so as to fall within the range of 3 to 7g/m².

FIG. 3 shows a carpet 1 according to a third embodiment of the present invention. This carpet 1 includes a base fabric 3 having piles 2 implanted on the upper surface of the base fabric 3 and a backing layer 4 formed on the lower surface of the base fabric 3. The backing layer 4 is made of a composition in which an allergen reducing agent 10 is contained in resin and/or rubber, and a part of the composition adheres to the pile foot portion 21 in an impregnated manner.

In the carpet 1 shown in FIG. 3, a part of the composition containing the allergen reducing agent 10 constituting the backing layer 4 is impregnated through the base fabric 3 and adheres to the pile foot portion 21. Therefore, the allergen reducing function 10 can effectively act on the allergens, such as, e.g., mites, dead mites or pollen, accumulated mainly at the pile foot portion 21.

In the third embodiment, the backing layer 4 is preferably made of a composition containing 2 to 20 mass parts allergen reducing agent with respect to 100 mass parts main component of resin and/or rubber. Sufficient allergen reducing effect can be attained when the allergen reducing agent is set to 2 mass parts or more, and the aggregation of the allergen reducing agent 10 in the composition can be prevented when the allergen reducing agent is set to 20 mass parts or less. Among other things, it is more preferable that the backing layer 4 is made of a composition containing 4 to 10 mass parts allergen reducing agent with respect to 100 mass parts main component of resin and/or rubber. Furthermore, in the case of containing a filler in the backing layer 4, it is preferable that 400 mass parts or less filler is contained with respect to 100 mass parts main component made of resin and/or rubber. The backing layer 4 can have a foam structure.

Furthermore, in the third embodiment, the adhered amount of the allergen reducing agent 10 is preferably set so as to fall within the range of 2 to 15 g/m². Sufficient allergen reducing effect can be attained when the adhered amount is set to 2 g/m² or more, and cost reduction can be attained when the adhered amount is set to 15 g/m² or less. Among other things, it is more preferable that the adhered amount of the allergen reducing agent is set so as to fall within the range of 3 to 8 g/m².

In the third embodiment, it is important that the composition constituting the backing layer 4 is impregnated (permeated) into the pile foot portion 21 located above the base fabric 3. From this aspect, it is preferable that the viscosity of the composition is set so as to fall within the range of 5,000 to 25,000 mPa·s. By setting it to 5,000 mPa·s or above, it becomes possible to prevent the baking material composition from being excessively permeated to reach the upper portion of the pile 2. By setting it to 25,000 mPa·s or less, it becomes possible to prevent the difficulty of permeation of the backing material composition and the unsuccessful reaching of the backing material composition to the foot portion of the pile 2. Among other things, it is more preferable that the viscosity of the composition is set so as to fall within the range of 10,000 to 20,000 mPa·s. It is especially important to control the viscosity immediately before applying it to the carpet. It is preferable that the heat and dry treatment of the composition is normally performed by heating it for 3 to 10 minutes at 100 to 180° C., although the condition varies depending on the material of the base fabric, the material of the pile, and/or the application amount of the backing composition.

In order to obtain a nice and soft feeling at the time of touching the pile surface of the carpet, it is important that the composition of the backing material is appropriately permeated to the foot portion 21 of the pile located above the base fabric 3. The permeation height from the upper surface of the base fabric 3 is preferably 0.2 to 2.5 mm.

It should give special attention to the permeation amount of the backing material composition to the pile foot portion 21 located above the base fabric 3 since the permeation amount varies depending on the revolution speed of the roll and the touching of the doctor knife to the carpet in the case of a roll coating method. The applied amount of the backing material composition is preferably set to 300 to 650 mL/m² so as to cope with any back stitch shape. By setting the applied amount to 300 mL/m² or more, it becomes possible to prevent the occurrence of application stain, resulting in uniform application. By setting it to 650 mL/m² or less, the hardening of the carpet can be prevented. Among other things, it is more preferable that the application amount of the backing material composition is set to 350 to 500 mL/m².

In this invention, the allergen reducing agent 10 is not specifically limited if it can inactivate allergens by denaturalization or the like to thereby control antigen-antibody reaction. Examples of the allergen reducing agent include vinylphenol, tyrosine, and 1,2-di(4-hydroxyphenyl)ethene, in addition to plant extract, such as, e.g., tannic acid or catechin, and hydroxybenzoic acid, such as, e.g., 2,5-dihydroxybenzoic acid. Among other things, in view of the application workability, washing resistance, and colorability, it is preferable to use an allergen reducing agent having a phenolic hydroxyl, such as, vinylphenol, tyrosine, or 1,2-di(4-hydroxyphenyl)ethane.

In this invention, the base fabric 3 can be any material and form if it can fix the allergen reducing agent 10. As the material of the base fabric 3, for example, thermoplastic fibers, such as, e.g., polyester series fiber, polyamide series fiber, or polyolefin series fiber, complex fibers of these fibers, semisynthetic fiber such as, e.g., acetate fiber, regenerated fiber, such as, e.g., rayon, natural fiber, such as, e.g., hemp or cotton, or mixing of these fibers, can be exemplified. As the form of the base fabric 3, for example, woven fabric, nonwoven fabric and knitted fabric can be exemplified.

Furthermore, the material of the pile 2 is not specifically limited, but a fiber product made of polyester fiber, nylon fiber, polypropylene fiber, acryl fiber, rayon fiber, etc., can be preferably used. In addition, a product made of natural fiber, such as, e.g., hemp, cotton, or wool, can be exemplified. The form of the pile 2 is also not limited, and a cut pile, a loop pile, etc., can be exemplified.

The backing material constituting the backing layer 4 is not specifically limited if it is resin or rubber capable of fixing the pile yarns to the base fabric. As the aforementioned resin, for example, acrylic series, urethane series, polyvinyl chloride, polyethylene, polypropylene, and ethylene-vinyl acetate copolymer (EVA) can be exemplified. As the aforementioned rubber, for example, SBR (styrene-butadiene rubber), NBR (acrylonitrile-butadiene rubber), MBR (methyl methacrylate-butadiene rubber), and natural rubber can be exemplified. It is preferable that the backing material contains filler. As the filler, although it is not specifically limited, for example, calcium carbonate, aluminum hydroxide, magnesium hydroxide, and fly ash can be exemplified. Additive agents, such as, e.g., dispersant, thickener, antibacterial agent, fire retardant, or odor eliminating agent, can be added to the backing material within the range not preventing the effects of the invention. Furthermore, on the lower surface of the backing layer 4, a secondary base fabric made of, e.g., nonwoven fabric or woven fabric, can be integrally laminated.

### EXAMPLES

Next, concrete examples of this invention will be explained.

### Example 1

50 mass parts tyrosine (allergen reducing agent) was dispersed in 100 mass parts water to obtain a solution, and 50 mass parts EVA resin was further dispersed into the solution to thereby obtain an aqueous dispersion. After applying this aqueous dispersion to one surface of a base fabric (tape yarn made of polypropylene fibers, the weight per unit area: 110 g/m²) by a spraying method, it was subjected to a dry treatment for 3 minutes at 110° C. to thereby obtain the base fabric with the allergen reducing agent adhering to the one surface. At this time, the adhered amount of the allergen reducing agent was 7 g/m². Next, piles (pile weight per unit area: 700 g/m²) made of polyester fibers were implanted to the base fabric from the other surface thereof using a tufting machine to thereby form cut piles having a pile length of 7 mm at the allergen reducing agent adhered side. Thus, a carpet original fabric was obtained. Next, SBR latex (containing calcium carbonate as filler) was applied onto the non-pile surface side (lower side) of the carpet original fabric, and then subjected to a dry treatment. Thus, a carpet having a structure shown in FIG. 1 was obtained.

### Example 2

A carpet having a structure shown in FIG. 1 was obtained in the same manner as in Example 1 except that the adhered amount of the allergen reducing agent on the upper surface of the base fabric was set to 10 g/m².

### Example 3

A carpet having a structure shown in FIG. 1 was obtained in the same manner as in Example 1 except that the adhered amount of the allergen reducing agent on the upper surface of the base fabric was set to 1.2 g/m².

### Comparative Example 1

A carpet was obtained in the same manner as in Example 1 except that no allergen reducing agent was applied.

### Comparative Example 2

A carpet having a structure shown in FIG. 1 was obtained in the same manner as in Example 1 except that the adhered amount of the allergen reducing agent on the upper surface of the base fabric was set to 0.9 g/m².

### Comparative Example 3

A carpet in which allergen reducing agent adhered to the pile surface was obtained in the same manner as in Example 1 except that an allergen reducing agent was sprayed from the pile surface side so that the adhered amount became 7 g/m² and then dried in place of making an allergen reducing agent adhere to the upper surface of the base fabric.

### Example 4

50 mass parts tyrosine (allergen reducing agent) was dispersed in 100 mass parts water to obtain a solution, and 50 mass parts EVA resin was further dispersed into the solution to thereby obtain an aqueous dispersion. A fabric in which a web (weight per unit area: 50 g/m²) and a base fabric (tape yarn made of polypropylene fibers, the weight per unit area: 110 g/m²) were integrally laminated by needling was impregnated in the aforementioned aqueous dispersion, and then dried for 3 minutes at 110° C. The adhered amount of the allergen reducing agent was 5 g/m². Next, piles (pile weight per unit area: 700 g/m²) made of polyester fibers are implanted to the base fabric from the other surface side thereof (non-laminated side) using a tufting machine to thereby form cut piles having a pile length of 7 mm at the web side. Thus, a carpet original fabric was obtained. Next, SBR latex (containing calcium carbonate as filler) was applied onto the non-pile surface side (lower side) of the carpet original fabric, and then subjected to a dry treatment. Thus, a carpet having a structure shown in FIG. 2 was obtained.

### Example 5

A carpet having a structure shown in FIG. 2 was obtained in the same manner as in Example 1 except that the adhered amount of the allergen reducing agent on the upper surface of the base fabric was set to 9 g/m².

### Example 6

A carpet having a structure shown in FIG. 2 was obtained in the same manner as in Example 1 except that the adhered amount of the allergen reducing agent on the upper surface of the base fabric was set to 1.5 g/m².

### Comparative Example 4

A carpet having a structure shown in FIG. 2 was obtained in the same manner as in Example 4 except that the adhered amount of the allergen reducing agent on the web layer was set to 0.6 g/m².

TABLE 1

| | Allergen reducing | Allergen reducing | Allergen reducing |
|---|---|---|---|
| | agent adhered | agent adhered | performance |
| | position | amount (g/m²) | evaluation results |
| Example 1 | Upper surface of | 7 | 1 |
| | the base fabric | | |
| Example 2 | Upper surface of | 10 | 1 |
| | the base fabric | | |
| Example 3 | Upper surface of | 1.2 | 2 |
| | the base fabric | | |
| Comparative | — | 0 | 4 |
| Example 1 | | | |
| Comparative | Upper surface of | 0.9 | 3 |
| Example 2 | the base fabric | | |
| Comparative | Pile surface area | 7 | 3 |
| Example 3 | | | |
| Example 4 | Web layer | 5 | 1 |
| Example 5 | Web layer | 9 | 1 |
| Example 6 | Web layer | 1.5 | 2 |
| Comparative | Web layer | 0.6 | 3 |
| Example 4 | | | |

### Example 7

Piles (pile weight per unit area: 700 g/m²) made of polyester fibers were implanted to the base fabric (tape yarn made of polypropylene fibers, the weight per unit area: 110 g/m²) from one side using a tufting machine to thereby form cut piles having a pile length of 7 mm. Thus, a carpet original fabric was obtained. Next, a backing composition having a viscosity of 20,000 mP·s obtained by adding 350 mass parts calcium carbonate, 10 mass parts tyrosine (allergen reducing agent), 2 mass parts thickening agent to 100 mass parts SBR latex (SBR containing rate: 50 mass parts) in a dispersed manner was made to foam by 1.7 times, and applied on the non-pile surface side (lower surface) of the carpet original fabric by wet 500 g/m² (490 mL/m²) by a roll coating method. Thereafter, it was subjected to a dry treatment for 10 minutes at 150° C. to thereby obtain a carpet having a structure shown in FIG. 3. The backing composition was impregnated to the pile foot portion, and adhered up to the height of 1.2 mm of the pile foot portion from the upper surface of the base fabric. The adhered amount of the allergen reducing agent was 7.5 g/m². The viscosity was measured using a BM viscosity measuring apparatus under the conditions of a type-4 rotor and 6 rpm.

### Example 8

A carpet having a structure shown in FIG. 3 was obtained in the same manner as in Example 7 except that the adhered amount of the allergen reducing agent was set to 10 g/m². The backing composition was impregnated to the pile foot portion, and adhered up to the height of 1.2 mm of the pile foot portion from the upper surface of the base fabric.

### Example 9

A carpet having a structure shown in FIG. 3 was obtained in the same manner as in Example 7 except that a backing composition having a viscosity of 10,000 mP·s obtained by adding 5 mass parts tyrosine (allergen reducing agent) was added to SBR latex (SBR containing rate: 50 mass parts) in a dispersed manner was used. The backing composition was impregnated to the pile foot portion, and adhered up to the height of 1.8 mm of the pile foot portion from the upper surface of the base fabric. The adhered amount of the allergen reducing agent was 5 g/m².

### Comparative Example 5

A carpet having a structure shown in FIG. 3 was obtained in the same manner as in Example 7 except that a backing composition obtained by adding 350 mass parts calcium carbonate and 1.2 mass parts tyrosine (allergen reducing agent) to 100 mass parts SBR latex (SBR containing rate: 50 mass %) in a dispersed manner was used so that the adhered amount of the allergen reducing agent became 0.9 g/m². The backing composition was impregnated up to the pile foot portion, and adhered up to the height of 1.2 mm of the pile foot portion from the upper surface of the base fabric.

### Comparative Example 6

A carpet was obtained in the same manner as in Example 7 except that a backing composition having a viscosity of 32,000 mPa·s obtained by adding 350 mass parts calcium carbonate, 10 mass parts tyrosine (allergen reducing agent) and 5 mass parts thickening agent to 100 mass parts SBR latex (SBR containing rate: 50 mass %) in a dispersed manner was used. The backing composition was not impregnated into to the pile foot portion at all, and the adhered position of the allergen reducing agent was only in the backing layer. The adhered amount of the allergen reducing agent was 7.5 g/m².

TABLE 2

| | Allergen reducing | Allergen reducing | Allergen reducing |
|---|---|---|---|
| | agent adhered | agent adhered | performance |
| | position | amount (g/m²) | evaluation results |
| Example 7 | Pile foot portion | 7.5 | 1 |
| | and backing layer | | |
| Example 8 | Pile foot portion | 10 | 1 |
| | and backing layer | | |
| Example 9 | Pile foot portion | 5 | 1 |
| | and backing layer | | |
| Comparative | Pile foot portion | 0.9 | 3 |
| Example 5 | and backing layer | | |
| Comparative | Only backing layer | 7.5 | 3 |
| Example 6 | | | |

Each carpet obtained as mentioned above was evaluated as follows.

<Allergen Reducing Performance (Inactivation Performance) Evaluation Method>

Allergen reducing performance of each carpet was evaluated using an allergen measuring kit (made by Asahi Beer Chemical Kabushiki Kaisha under the trade name of “DANISCAN”). Initially, dust 3 mg obtained from a conventional carpet (not a carpet according to the present invention) which had been used for 3 years was disposed on each carpet (Examples 1 to 9, Comparative Examples 1 to 6) cut into 5 cm×5 cm, and then rubbed into the carpet so as not to be recognized. Then each sample was left for 2 days under the conditions of 25° C.×70% R.H. Next, the pile of each carpet was cut, and the cut surface was rubbed with a dust sampler. Then, developer of the measuring kit was dropped on the dust sampler, and the mite contamination state was evaluated based on the contrasting density and the position of the appeared red line on the scale of 4 scale evaluation. Evaluations [1] and [2] are considered to be acceptable.

(Evaluation Criteria)

[1] . . . Not contaminated by mite allergens
[2] . . . Slightly contaminated by mite allergens
[3] . . . Contaminated by mite allergens
[4] . . . Severely contaminated by mite allergens

As will be apparent from the Table, the carpets of Examples 1 to 9 according to the present invention was excellent in mite allergen reducing performance, and no or almost no mite allergen contamination was found. To the contrary, the carpet of Comparative Examples 1 to 6 had no or insufficient mite allergen reducing performance, and were contaminated by mite allergens.

This application claims priority to Japanese Patent Application No. 2004-68978 filed on Mar. 11, 2004 and Japanese Patent Application No. 2004-68979 filed on Mar. 11, 2004, the entire disclosure of which are incorporated herein by reference in their entireties.

It should be appreciated that the terms and descriptions herein are used only for explaining embodiments of the present invention, and the present invention is not limited to them. The present invention permits any design modifications within the scope of the present invention defined by the appended claims unless they deviate from its spirit of the present invention.

### INDUSTRIAL APPLICABILITY

The carpet according to the present invention can be used as, for example, a laying carpet, a hot carpet, a bath mat, a toilet mat, and a tile carpet.

1. A carpet having piles provided on an upper surface of a base fabric and a backing layer formed on a lower surface of the base fabric,
wherein an allergen reducing agent is made to adhere to at least a part of an area ranging from the upper surface of the base fabric to a foot portion of the pile.

2. A carpet having piles provided on an upper surface of a base fabric and a backing layer formed on a lower surface of the base fabric,
wherein an allergen reducing agent is made to adhere to the upper surface of the base fabric.

3. A carpet having piles provided on an upper surface of a base fabric and a backing layer formed on a lower surface of the base fabric,
wherein a web layer to which an allergen reducing agent is made to adhere is integrally laminated on the upper surface of the base fabric.

4. The carpet as recited in claim 3, wherein the base fabric and the web layer are integrally laminated by needling.

5. The carpet as recited in claim 3, wherein weight per unit area of the web layer is 10 to 100 g/m².

6. The carpet as recited in claim 5, wherein an adhered amount of the allergen reducing agent is 1 to 10 g/m².

7. A carpet having piles provided on an upper surface of a base fabric and a backing layer formed on a lower surface of the base fabric,
wherein the backing layer is made of a composition in which an allergen reducing agent is contained in resin and/or rubber, and
wherein a part of the composition is permeated in and adhered to a foot portion of the pile.

8. The carpet as recited in claim 7, wherein the backing layer is made of a composition containing 2 to 20 mass parts allergen reducing agent with respect to 100 mass parts main component of resin and/or rubber.

9. The carpet as recited in claim 7, wherein an adhered amount of the allergen reducing agent is 2 to 15 g/m².

10. The carpet as recited in claim 9, wherein an allergen reducing agent having a phenolic hydroxyl group is used as the allergen reducing agent.

11. A manufacturing method of a carpet, comprising:
applying a composition with viscosities of 5,000 to 25,000 mPa·s containing 2 to 20 mass parts allergen reducing agent with respect to 100 mass parts main component of resin and/or rubber onto a lower surface of a base fabric provided with pile on an upper surface of the base fabric; and thereafter
drying the composition applied to the base fabric.

12. The manufacturing method of a carpet as recited in claim 11, wherein the composition is applied to the lower surface of the base fabric by a roll coating method.

13. The carpet as recited in claim 1, wherein an adhered amount of the allergen reducing agent is 1 to 10 g/m²

14. The carpet as recited in claim 2, wherein an adhered amount of the allergen reducing agent is 1 to 10 g/m².

15. The carpet as recited in claim 3, wherein an adhered amount of the allergen reducing agent is 1 to 10 g/m².

16. The carpet as recited in claim 4, wherein an adhered amount of the allergen reducing agent is 1 to 10 g/m².

17. The carpet as recited in claim 1, wherein an allergen reducing agent having a phenolic hydroxyl group is used as the allergen reducing agent.

18. The carpet as recited in claim 2, wherein an allergen reducing agent having a phenolic hydroxyl group is used as the allergen reducing agent.

19. The carpet as recited in claim 3, wherein an allergen reducing agent having a phenolic hydroxyl group is used as the allergen reducing agent.

20. The carpet as recited in claim 7, wherein an allergen reducing agent having a phenolic hydroxyl group is used as the allergen reducing agent.
